(19) United States
(12) Patent Application Publication
(10) Pub. No.: US 2022/0164588 A1
(43) Pub. Date: May 26, 2022

(54) STORAGE MEDIUM, MACHINE LEARNING METHOD, AND OUTPUT DEVICE

(71) Applicant: FUJITSU LIMITED, Kawasaki-shi (JP)

(72) Inventor: Moyuru YAMADA, Machida (JP)

(73) Assignee: FUJITSU LIMITED, Kawasaki-shi (JP)

(21) Appl. No.: 17/472,717

(22) Filed: Sep. 13, 2021

(30) Foreign Application Priority Data
Nov. 20, 2020 (JP) 2020-193686

(51) Int. Cl. G06K 9/32; G06K 9/46; G06K 9/00; G06N 3/08; G06F 16/35; G06F 16/33

(52) U.S. Cl. CPC G06K 9/3233; G06K 9/4671; G06F 16/3344; G06N 3/08; G06F 16/355; G06K 9/00979

(57) ABSTRACT

A non-transitory computer-readable storage medium storing a machine learning program for causing a computer to execute a process includes acquiring a plurality of vectors that indicate a feature of each of a plurality of partial images extracted from an image; calculating a same number of vectors as a certain number of vectors based on the plurality of vectors and the certain number of vectors; and changing parameters of a neural network by executing machine learning based on vectors that indicate a feature of text and the same number of vectors.

### CROSS-REFERENCE TO RELATED APPLICATION

This application is based upon and claims the benefit of priority of the prior Japanese Patent Application No. 2020-193686, filed on Nov. 20, 2020, the entire contents of which are incorporated herein by reference.

### FIELD

The embodiments discussed herein are related to a storage medium, a machine learning method, and an output device.

### BACKGROUND

In recent years, there has been known a technique of inputting an image and a sentence instruction for the image into a computer system and working out an answer to the sentence instruction.

For example, there has been known an information processing device that, when the question text (sentence instruction) “What color is the hydrant?” is input along with an image in which a red hydrant is captured, outputs the answer “red” or, when the question text “How many people are in the image?” is input along with an image in which a plurality of persons is captured, outputs the number of people shown in the image.

FIG. 17 is a diagram for explaining processing in a prevalent computer system.

In this FIG. 17, an example in which the question text “Where is the location of this scene?” is input along with the image of a museum is illustrated.

The input question text is tokenized (partitioned) and then vectorized into a feature amount. Meanwhile, as for the image, a plurality of objects (images) is extracted by a material object detector, and each object is individually vectorized into a feature amount. These question text and objects vectorized into feature amounts are input to a neural network, and the answer “Museum” is output.

Japanese Laid-open Patent Publication No. 2017-91525 is disclosed as related art.

### SUMMARY

According to an aspect of the embodiments, a non-transitory computer-readable storage medium storing a machine learning program for causing a computer to execute a process includes acquiring a plurality of vectors that indicate a feature of each of a plurality of partial images extracted from an image; calculating a same number of vectors as a certain number of vectors based on the plurality of vectors and the certain number of vectors; and changing parameters of a neural network by executing machine learning based on vectors that indicate a feature of text and the same number of vectors.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a functional configuration of a computer system as an example of an embodiment;

FIG. 2 is a diagram schematically illustrating a functional configuration of an object integration unit of the computer system as an example of the embodiment;

FIG. 3 is a diagram for explaining bidirectional encoder representations from transformers (BERT);

FIG. 4 is a diagram depicting an arrangement of the object integration unit of the computer system as an example of the embodiment;

FIG. 5 is a diagram depicting a seed vector in the computer system as an example of the embodiment;

FIG. 6 is a diagram illustrating an example of correlation normalization in the computer system as an example of the embodiment;

FIG. 7 is a diagram illustrating an example of the calculation of a correction vector in the computer system as an example of the embodiment;

FIG. 8 is a diagram for explaining processing in the computer system as an example of the embodiment;

FIG. 9 is a diagram for explaining objects integrated in the computer system as an example of the embodiment;

FIG. 10 is an enlarged diagram of each vector depicted in FIG. 9;

FIG. 11 is a flowchart for explaining processing by the object integration unit in the computer system as an example of the embodiment;

FIG. 12 is a diagram depicting a hardware configuration of an information processing device that achieves the computer system as an example of the embodiment;

FIG. 13 is a diagram depicting an arrangement of an object integration unit of a computer system as a modification of the embodiment;

FIG. 14 is a diagram depicting another arrangement of the object integration unit of the computer system as an example of the embodiment;

FIG. 15 is a diagram for explaining processing in the computer system as the modification of the embodiment;

FIG. 16 is a diagram for explaining objects integrated in the computer system as the modification of the embodiment; and

FIG. 17 is a diagram for explaining processing in a prevalent computer system.

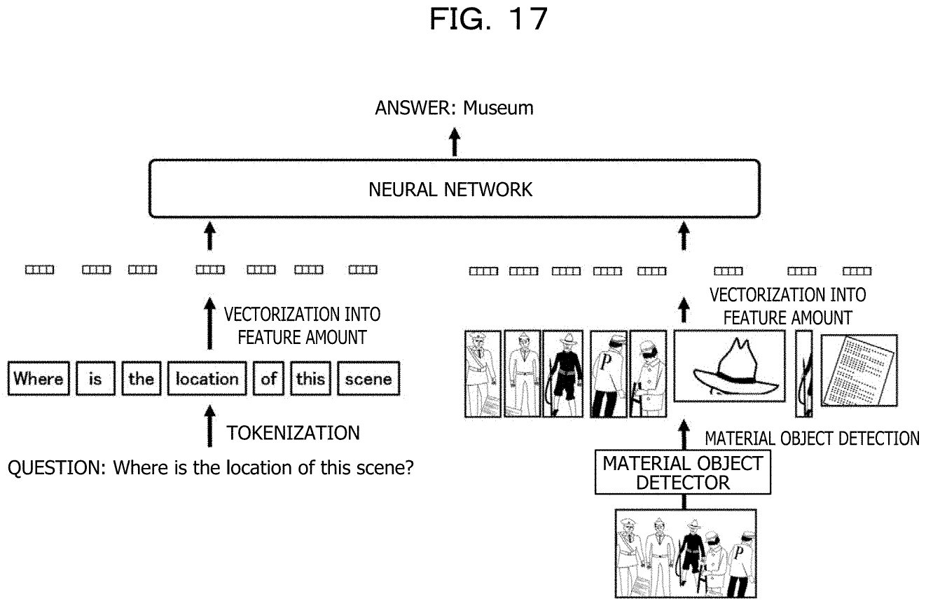

### DESCRIPTION OF EMBODIMENTS

It is desirable that objects extracted from an image be useful for solving a task, but in reality, there are cases where the same object is cut out in duplicate in different areas, or an area that does not clearly show what appears is extracted as an object.

For example, when the question text is “What color is the kid's hair?”, it is desirable that an area containing the kid's hair in the image be extracted as an object, but areas unrelated to the question text, such as a portion near the kid's hand in the image, are often extracted as objects.

This causes the problem that the number of objects to be processed is expanded and the computation cost is increased. Furthermore, it becomes difficult for a person to understand how objects are processed.

Thus, it is conceivable to lessen the number of objects by integrating a plurality of detected objects.

For example, an approach of integrating objects so as to put together overlapping parts based on the coordinate values on the image is conceivable. However, in such a prevalent object integration approach, since it is not considered which object is needed to solve the task, information unneeded to solve the task sometimes remains, while needed information is sometimes deleted.

For example, even when question text that needs attention to a particular facial component is input, simply integrating according to coordinates (overlap) will sometimes integrate the entire face and hair (+ other facial parts).

In one aspect, the present embodiment aims to enable efficient integration of a plurality of partial images extracted from an image.

According to one embodiment, a plurality of partial images extracted from an image may be efficiently integrated.

Hereinafter, embodiments relating to the present machine learning program, machine learning method, and output device will be described with reference to the drawings. However, the embodiment to be described below is merely an example, and there is no intention to exclude application of various modifications and techniques not explicitly described in the embodiment. For example, the present embodiment may be modified in various ways to be implemented without departing from the gist thereof. Furthermore, each drawing is not intended to include only the constituent elements illustrated in the drawing and may include other functions and the like.

(A) Configuration

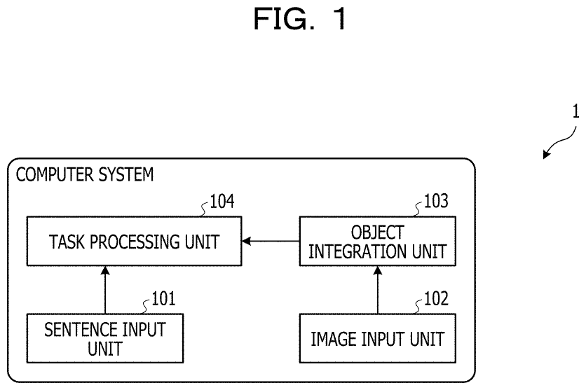

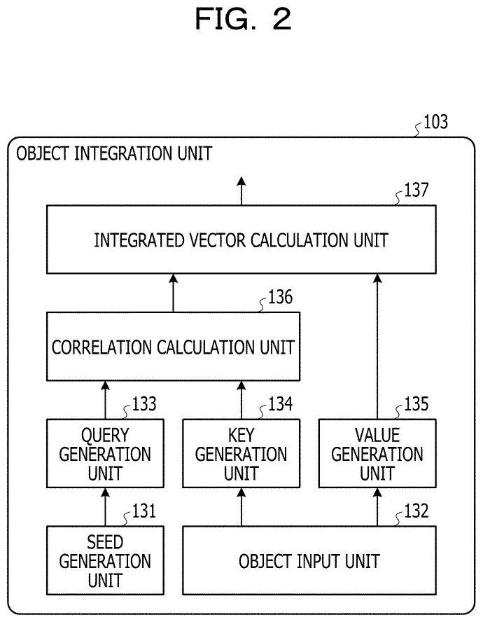

FIG. 1 is a diagram schematically illustrating a functional configuration of a computer system 1 as an example of an embodiment, and FIG. 2 is a diagram schematically illustrating a functional configuration of an object integration unit 103 of the computer system 1.

The present computer system 1 is a processing device (output device) in which an image and a sentence (question text) are input and an answer to the question text is output. Furthermore, the present computer system 1 is also a machine learning device in which an image and a sentence (question text) are input and an answer to the question text is also input as teacher data.

As illustrated in FIG. 1, the computer system 1 has functions as a sentence input unit 101, an image input unit 102, an object integration unit 103, and a task processing unit 104.

A sentence (text) regarding the input image is input to the sentence input unit 101. In the present computer system 1, question text regarding the input image is input as a sentence, and it is desirable that the question text be such that an answer is obtained by visually recognizing the input image, for example.

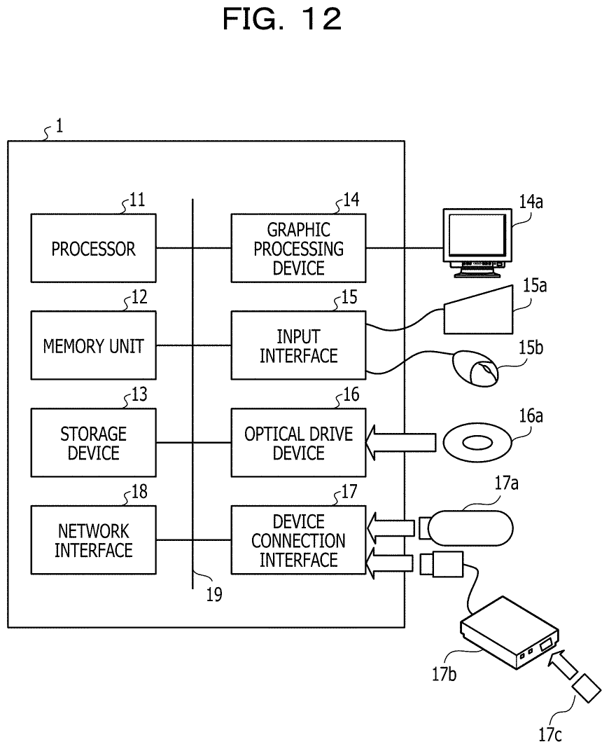

For example, the sentence may be input by a user using an input device such as a keyboard 15a or a mouse 15b (refer to FIG. 12), which will be described later. Furthermore, the sentence may be selected by an operator from among one or more sentences stored in a storage area of a storage device 13 or the like, or may be received via a network (not illustrated).

The sentence input unit 101 tokenizes (partitions) a sentence that has been input (hereinafter, sometimes referred to as an input sentence). The sentence input unit 101 has a function as a tokenizer and partitions a character string of the input sentence in units of terms (tokens or words). Note that the function as a tokenizer is known, and detailed description of the function will be omitted. The token constitutes a part of the input sentence and may be called a partial sentence.

Furthermore, the sentence input unit 101 digitizes each generated token by converting each token into a feature vector. The approach for vectorizing a token into a feature is known, and a detailed description of the approach will be omitted. The feature vector generated based on the token is sometimes referred to as a sentence feature vector. The sentence feature vector corresponds to a vector that indicates the feature of the text.

The sentence feature vector generated by the sentence input unit 101 is input to the task processing unit 104.

The sentence feature vector can be expressed as, for example, following formula (1).

$$\begin{matrix}[ Mathematical Formula 1 ] & \\ Sentence Feature Amount Vector \text{Y:} [ \begin{matrix}{y}_{1} \\ {y}_{2} \\ {y}_{3}\end{matrix} ] & ( 1 )\end{matrix}$$

The sentence feature vector Y expressed by above formula (1) includes three vector elements y₁, y₂, and y₃. Each of these vector elements y₁ to y₃ is a d-dimensional (for example, d=4) vector, and each is relevant to one token.

An image is input to the image input unit 102. For example, the image may be selected by an operator from among one or more images stored in a storage area of the storage device 13 (refer to FIG. 12) described later or the like, or may be received via a network (not illustrated).

The image input unit 102 extracts a plurality of objects from the image that has been input (hereinafter, sometimes referred to as an input image). The image input unit 102 has a function as a material object (object) detector and generates an object by extracting a part of the input image from the input image. Note that the function as a material object detector is known, and detailed description of the function will be omitted. The object constitutes a part of the input image and may be called a partial image.

Furthermore, the image input unit 102 digitizes each generated object by converting each object into a feature vector. The approach for vectorizing an object into a feature is known, and a detailed description of the approach will be omitted. The feature vector generated based on the partial image is sometimes referred to as an image feature vector.

The image feature vector generated by the image input unit 102 is input to the object integration unit 103.

In the present computer system 1, bidirectional encoder representations from transformers (BERT) may be adopted.

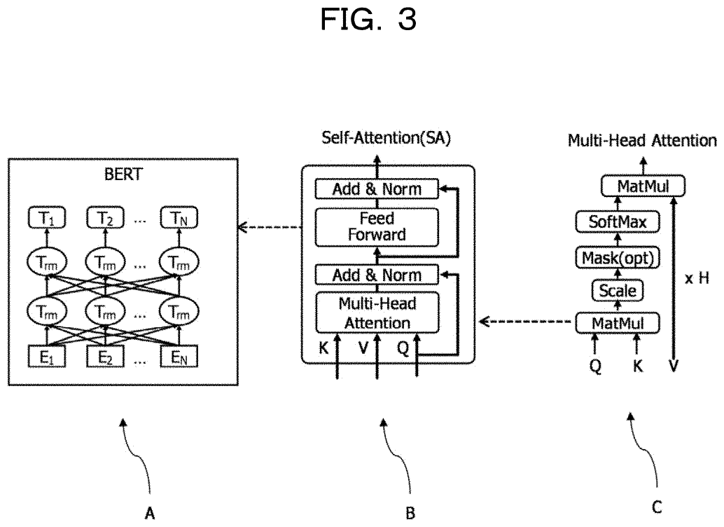

FIG. 3 is a diagram for explaining BERT.

In FIG. 3, the reference sign A indicates the configuration of BERT, and the reference sign B indicates the configuration of each self-attention provided in BERT. Furthermore, the reference sign C indicates the configuration of multi-head attention contained in self-attention.

BERT has a structure in which encoder units (that perform self-attention) of a transformer are stacked.

The attention is an approach of computing the correlation between a query (query vector) and a key (key vector) and acquiring a value (value vector) based on the computed correlation.

Self-attention represents a case where inputs for working out the query, the key, and the value are the same.

For example, it is assumed that the query is a dog image vector, and the respective keys and values are four vectors of [This] [is] [my] [dog].

The idea in such a case is that the correlation between the key ([dog]) and the query is high and the value ([dog]) is acquired. Note that, actually, a weighted sum of each value such as [This]: 0.1, [is]: 0.05, [my]: 0.15, [dog]: 0.7 is generated.

Then, by layering a plurality of transformers, it is possible to solve a more complicated task that needs multi-step inference.

The object integration unit 103 integrates the objects into a specified number of objects. Hereinafter, the number of objects after integration is sometimes referred to as an integration number. The integration number may be specified by the operator.

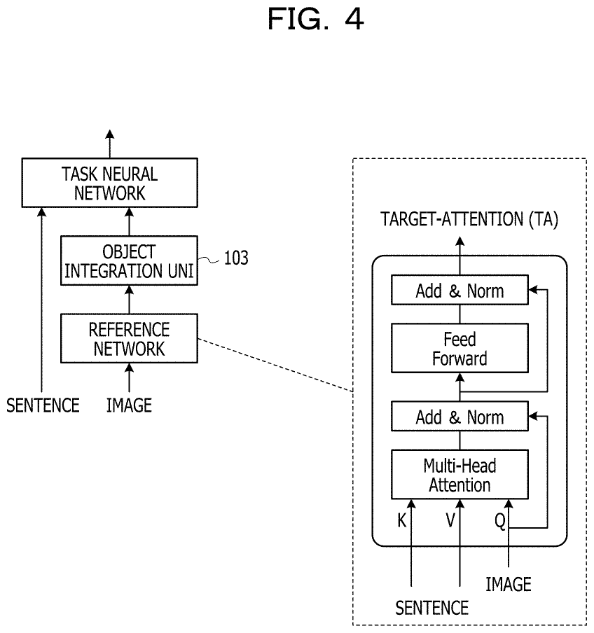

FIG. 4 is a diagram depicting an arrangement of the object integration unit 103 of the computer system 1 as an example of the embodiment.

In the example illustrated in FIG. 4, the object integration unit 103 is arranged between a reference network and a task neural network.

The reference network is achieved by, for example, target-attention provided in the decoder unit of the transformer depicted in FIG. 3. The reference network acquires the value generated from each word based on the correlation between the query (Q) generated from a feature vector of the object (partial image) and the key (K) generated from each word (token) in the sentence, and adds the acquired value to the feature vector of the original object.

This reflects weighting based on the sentence in the feature vector (image feature vector) of the object input to the object integration unit 103. For example, the vectorized sentence (sentence feature vector) is input to both of the task neural network and the reference network. This allows the object integration unit 103 to integrate only objects associated with the question text.

As illustrated in FIG. 2, the object integration unit 103 has functions as a seed generation unit 131, an object input unit 132, a query generation unit 133, a key generation unit 134, a value generation unit 135, a correlation calculation unit 136, and an integrated vector calculation unit 137.

The seed generation unit 131 generates and initializes a seed vector. The seed vector represents a vectorized image after integration and includes a plurality of seeds (seed vector elements). The seed generation unit 131 generates the same number of seeds as the integration number.

The seed vector can be expressed as, for example, following formula (2).

$$\begin{matrix}[ Mathematical Formula 2 ] & \\ Seed Vector \text{X:} [ \begin{matrix}{x}_{1} \\ {x}_{2} \\ {x}_{3}\end{matrix} ] & ( 2 )\end{matrix}$$

The seed vector expressed by above formula (2) includes three elements (seeds) x₁, x₂, and x₃. Each of x₁ to x₃ constituting the seed vector is a d-dimensional (for example, d=4) vector, and each is relevant to one object.

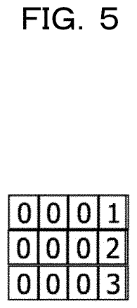

FIG. 5 is a diagram depicting a seed vector in the computer system 1 as an example of the embodiment.

In FIG. 5, the seed vector including the vectors x₁ to x₃ expressed by formula (2) is expressed as a matrix of three rows and four columns. The respective rows individually represent a single seed configured as a d-dimensional (d=3 in the example illustrated in FIG. 5) vector.

The seed generation unit 131 sets different initial values for each of a plurality of seeds constituting the seed vector. This avoids the queries generated for each seed by the query generation unit 133, which will be described later, from having the same value.

The image feature vector input from the image input unit 102 is input to the object input unit 132.

The object input unit 132 inputs the input image feature vector to each of the key generation unit 134 and the value generation unit 135.

The query generation unit 133 calculates (generates) a query from each of the seeds generated by the seed generation unit 131. Note that the calculation of the query based on the seed may be achieved using, for example, an approach similar to the known approach of generating the query from the question text, and the description of the approach will be omitted.

Since the query is generated from the seed vector and the key and the value are generated from the image feature vector regularly, the object integration unit 103 is regarded as target-attention.

The query can be expressed as, for example, following formula (3) at the time of target-attention (when the image is employed as a query).

$$\begin{matrix}[ Mathematical Formula 3 ] & \\ Q = {W}_{Q} X = [ \begin{matrix}{q}_{1} \\ {q}_{2} \\ {q}_{3}\end{matrix} ] & ( 3 )\end{matrix}$$

Note that, in above formula (3), it is assumed that W_{Q} has been worked out by learning.

Furthermore, the query (Q) has the same dimensions as the seed vector X and the image feature vector, and for example, when x₁ is four-dimensional (d=4), q₁ is also four-dimensional.

The key generation unit 134 generates a key based on the image feature vector input from the object input unit 132. Note that the generation of the key based on the image feature vector may be achieved by a known approach, and the description of the approach will be omitted.

The key (K) can be expressed as, for example, following formula (4).

$$\begin{matrix}[ Mathematical Formula 4 ] & \\ K = {W}_{K} X = [ \begin{matrix}{k}_{1} \\ {k}_{2} \\ {k}_{3}\end{matrix} ] & ( 4 )\end{matrix}$$

Note that, in above formula (4), it is assumed that the weight W_{K} has been worked out by training (machine learning).

The value generation unit 135 generates a value (value vector) based on the image feature vector input from the object input unit 132. Note that the generation of the value based on the image feature vector may be achieved by a known approach, and the description of the approach will be omitted.

The value (V) can be expressed as, for example, following formula (5).

$$\begin{matrix}[ Mathematical Formula 5 ] & \\ V = {W}_{V} X = [ \begin{matrix}{v}_{1} \\ {v}_{2} \\ {v}_{3}\end{matrix} ] & ( 5 )\end{matrix}$$

Note that, in above formula (5), it is assumed that the weight W_{V} has been worked out by training (machine learning).

The correlation calculation unit 136 calculates a correlation C from the inner product between the queries generated by the query generation unit 133 and the keys generated by the key generation unit 134.

The correlation calculation unit 136 calculates the correlation between vectors as indicated by following formula (6), for example.

$$\begin{matrix}[ Mathematical Formula 6 ] & \\ Score = Q \cdot {K}^{T} = [ \begin{matrix}{q}_{1} \\ {q}_{2} \\ {q}_{3}\end{matrix} ] [ \begin{matrix}{k}_{1}^{T} & {k}_{2}^{T} & {k}_{3}^{T} ]\end{matrix} & ( 6 )\end{matrix}$$

Furthermore, an example of the calculated correlation (score) is indicated below.

$$Score = [ \begin{matrix}1.49 & 1.68 & 1.74 \\ 0.31 & 0.16 & 1.17 \\ 0.88 & 1.47 & 0.84\end{matrix} ] \qquad [ Mathematical Formula 7 ]$$

In addition, since the inner product sometimes becomes excessively large, it is desirable for the correlation calculation unit 136 to divide the calculated correlation (score) by a constant a (score=score/a).

Moreover, the correlation calculation unit 136 normalizes the calculated correlation.

For example, the correlation calculation unit 136 normalizes the correlation using a softmax function. The softmax function is a neural network activation function that returns a value supposed to give the sum of a plurality of output values as “1.0” (=100%). Hereinafter, the normalized correlation is sometimes represented by the reference sign Att. Att is expressed by following formula (7).

$$\begin{matrix}[ Mathematical Formula 8 ] & \\ R = Att \cdot V = [ \begin{matrix}{r}_{1} \\ {r}_{2} \\ {r}_{3}\end{matrix} ] & ( 8 )\end{matrix}$$

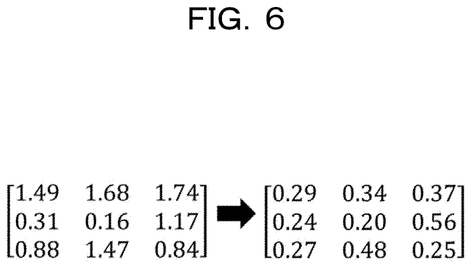

FIG. 6 is a diagram illustrating an example of correlation normalization in the computer system 1 as an example of the embodiment.

In this FIG. 6, an example in which Att is calculated by normalizing the above-mentioned values of the score is illustrated.

The integrated vector calculation unit 137 calculates an inner product A between the correlation C calculated by the correlation calculation unit 136 and the values generated by the value generation unit 135 to calculate the vector of the objects that has been integrated (hereinafter, sometimes referred to as an integrated vector F). The inner product A is given as a weighted sum.

The integrated vector calculation unit 137 calculates a correction vector using the correlation Att and the value (V). The integrated vector calculation unit 137 calculates a correction vector (R) as indicated by following formula (8), for example.

$$Att = Softmax ( Score ) \qquad ( 7 )$$

Note that the correction vector=the integrated vector may be assumed. Furthermore, in above formula (8), normalization may be performed after Att·V, and various modifications may be made and implemented.

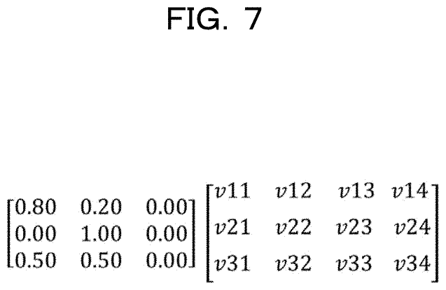

FIG. 7 illustrates an example of the calculation of a correction vector in the computer system 1 as an example of the embodiment.

In this example illustrated in FIG. 7, it is indicated that Value 3 (v31 v32 v33 v34) disappears due to integration.

The task processing unit 104 computes an output specialized for the task.

The task processing unit 104 has functions as a learning processing unit and an answer output unit.

The learning processing unit accepts inputs of the image feature vector generated based on the image and the sentence feature vector generated based on the sentence (question text) as teacher data, and constructs a learning model that outputs a response to the question text by deep learning (artificial intelligence (AI)).

For example, at the time of learning, the task processing unit 104 executes machine learning of a model (task neural network) based on vectors indicating the feature of the sentence feature vector text and the same number of integrated vectors.

Then, the seed vectors and the query vectors (a certain number of vectors) are updated according to such machine learning.

Note that the construction of such a learning model in which the image feature vector and the sentence feature vector are input and a response to the question text is output may be achieved using a known approach, and detailed description of the approach will be omitted.

The answer output unit outputs a result (answer) obtained by inputting the sentence feature vectors and the same number of integrated vectors to the model (task neural network or machine learning model).

Furthermore, such an approach of inputting the image feature vector and the sentence feature vector to the learning model and outputting a response to the question text may be achieved using a known approach, and detailed description of the approach will be omitted.

In addition, the task processing unit 104 may have a function as an evaluation unit that evaluates the learning model constructed by the learning processing unit. For example, the evaluation unit may verify whether an overlearning state has been reached, or the like.

The evaluation unit inputs the image feature vector generated based on the image and the sentence feature vector generated based on the sentence (question text) to the learning model created by the learning processing unit as evaluation data, and acquires a response (prediction result) to the question text.

The evaluation unit evaluates the accuracy of the prediction result output based on the evaluation data. For example, the evaluation unit may determine whether the difference between the accuracy of a prediction result output based on the evaluation data and the accuracy of a prediction result output based on the teacher data is within a permissible threshold. For example, the evaluation unit may determine whether the accuracy of a prediction result output based on the evaluation data and the accuracy of a prediction result output based on the teacher data are at the same level of accuracy.

(B) Operation

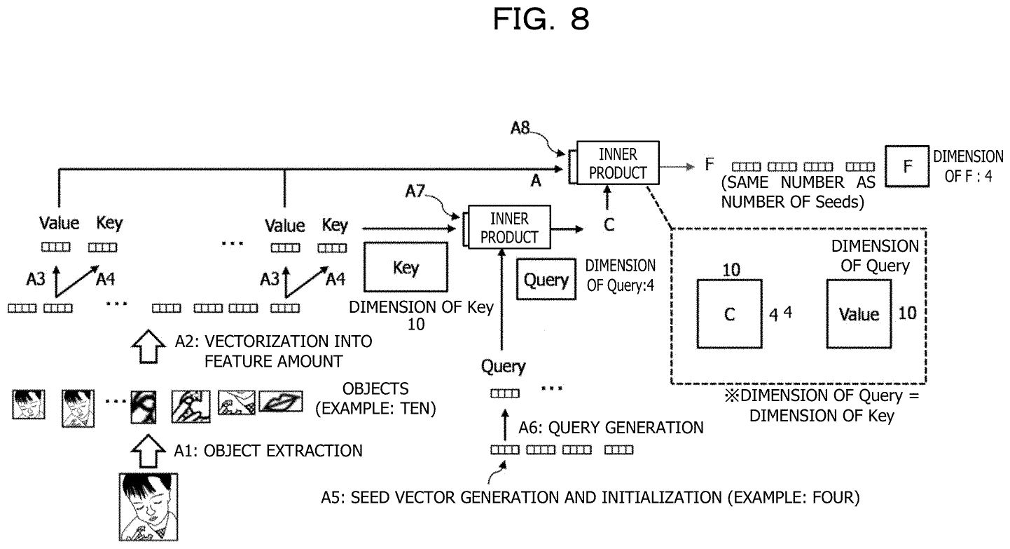

The processing in the computer system 1 as an example of the embodiment configured as described above will be described with reference to FIG. 8.

The image input unit 102 extracts a plurality of objects from the input image (refer to the reference sign A1). In FIG. 8, an example in which the image input unit 102 generates ten objects from the input image is illustrated.

The image input unit 102 generates a plurality of image feature vectors by converting each generated object into a feature vector (refer to the reference sign A2).

The value generation unit 135 generates a value based on the image feature vector (refer to the reference sign A3). In FIG. 8, an example in which ten four-dimensional values are generated is illustrated.

The key generation unit 134 generates a key based on the image feature vector (refer to the reference sign A4). In FIG. 8, an example in which the dimension of the key is ten is illustrated.

Meanwhile, the seed generation unit 131 generates and initializes the seed vector (refer to the reference sign A5). In the example illustrated in FIG. 8, the seed generation unit 131 generates four seeds (four dimensions).

The query generation unit 133 calculates (generates) a query from each of the seeds generated by the seed generation unit 131 (refer to the reference sign A6). In FIG. 8, an example in which the dimension of the query is four is illustrated.

The correlation calculation unit 136 calculates the correlation C by the inner product between the queries generated by the query generation unit 133 and the keys generated by the key generation unit 134 (refer to the reference sign A7). In the example illustrated in FIG. 8, the correlation C of four rows and ten columns is generated. Values constituting the correlation C represent the degree of attention to the concerned object, and the larger the values, the more attention is paid to the concerned object.

Thereafter, the integrated vector calculation unit 137 calculates the inner product A between the correlation C calculated by the correlation calculation unit 136 and the values generated by the value generation unit 135 to calculate the vector F of the objects that has been integrated (refer to the reference sign A8).

In the example illustrated in FIG. 8, the integrated vector calculation unit 137 calculates the inner product A between the correlation C of four rows and ten columns and the values of ten rows and four columns, thereby generating four four-dimensional vectors F. For example, this represents that the ten objects extracted from the input image by the image input unit 102 have been integrated into four.

In the present computer system 1, the object integration unit 103 is arranged downstream of the reference network, such that the objects are integrated based on both of the input image and the input question text.

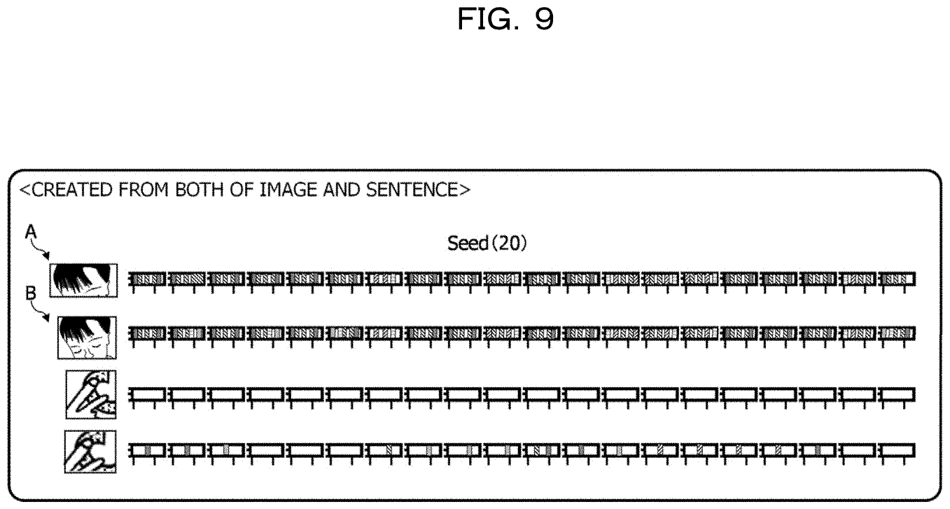

FIG. 9 is a diagram for explaining objects integrated in the computer system 1 as an example of the embodiment.

In this FIG. 9, vectors integrated when the input image is a photograph of a kid's face and the question text is “What color is the kid's hair?” is represented. In this FIG. 9, an example in which the number of seeds is 20 is illustrated.

In this FIG. 9, the 20 rectangles placed side by side at each object image each represent vectors that have been integrated.

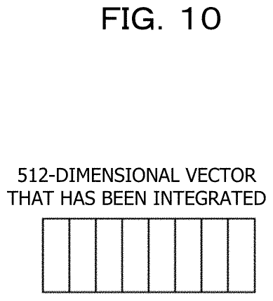

FIG. 10 is an enlarged diagram of each vector depicted in FIG. 9. Each vector is, for example, a 512-dimensional vector and is configured as a combination of eight types of information with 64 dimensions as one unit. For example, the vector depicted in FIG. 10 is partitioned into eight areas, and each area is individually relevant to a head in multi-head attention (refer to FIG. 3).

The eight types of information in each vector are each relevant to information such as the color, shape, and the like of the image and are each weighted according to the question text. In the example illustrated in FIG. 9, a portion relevant to an image attracting attention in the calculation of each vector is represented by hatching.

By arranging the object integration unit 103 on a downstream side of the reference network, the objects are integrated based on both of the image and the question text.

This reflects the question text “What color is the kid's hair?” in the integration of the objects. In the example illustrated in FIG. 9, the weight of the image containing the kid's hair is raised, and only the objects containing the hair are integrated (refer to the reference signs A and B).

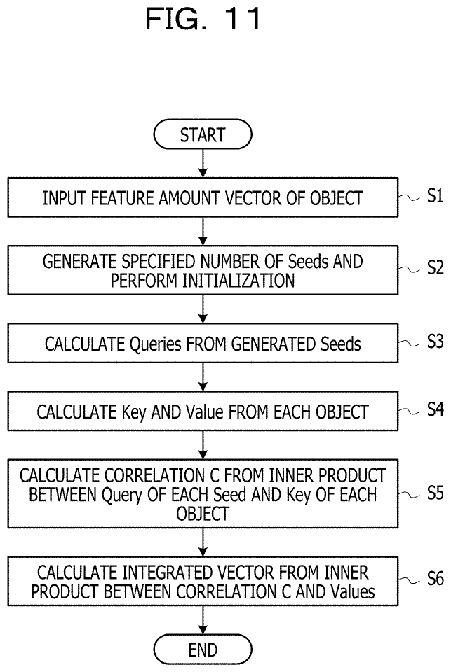

Next, the processing by the object integration unit 103 in the computer system 1 as an example of the embodiment configured as described above will be described in accordance with the flowchart (steps S1 to S6) illustrated in FIG. 11.

In step S1, the object input unit 132 inputs the image feature vector input from the image input unit 102 to each of the key generation unit 134 and the value generation unit 135.

In step S2, the seed generation unit 131 generates a specified number (integration number) of seeds and sets different values for these seeds to perform initialization.

In step S3, the query generation unit 133 calculates (generates) a query from each of the seeds generated by the seed generation unit 131.

In step S4, the key generation unit 134 generates a key based on the image feature vector input from the object input unit 132. Furthermore, the value generation unit 135 generates a value based on the image feature vector input from the object input unit 132.

In step S5, the correlation calculation unit 136 calculates the correlation C from the inner product between the queries generated by the query generation unit 133 and the keys generated by the key generation unit 134.

In step S6, the integrated vector calculation unit 137 calculates the inner product A between the correlation C calculated by the correlation calculation unit 136 and the values generated by the value generation unit 135 to calculate the integrated vector F. Thereafter, the processing ends.

The generated integrated vector is input to the task processing unit 104 along with the sentence feature vector. At the time of learning, the task processing unit 104 executes machine learning of a model (task neural network) based on vectors indicating the feature of the sentence feature vector text and the same number of integrated vectors.

Furthermore, at the time of answer output, the task processing unit 104 outputs a result (answer) obtained by inputting the sentence feature vectors and the same number of integrated vectors to the machine learning model.

(C) Effects

As described above, according to the computer system 1 as an example of the embodiment, the object integration unit 103 integrates a plurality of objects generated by the image input unit 102 and generates the integrated vector. This enables the reduction of the number of objects input to the task processing unit 104 and the reduction of the of computation during the learning processing and the answer output.

For example, when the number of objects detected from one input image is about 100, the of computation may be lowered to one fifth by integrating these 100 objects and decreasing the number of objects to 20.

Furthermore, for example, by reducing the nearly 100 objects including duplicates to about 5 to 20, the objects may be made easier to visualize. This may allow to grasp how the objects have been integrated, which may also allow to visualize objects that the system is paying attention to. For example, it becomes easier for an administrator to understand the behavior of the system.

The seed generation unit 131 generates the same number of seeds as the integration number, and the query generation unit 133 generates a query from each of these seeds. Then, the correlation calculation unit 136 calculates the correlation C from the inner product between these queries and the keys generated based on the image feature vectors. Then, the integrated vector calculation unit 137 calculates the inner product A between this correlation C and the values generated from the image feature vectors, thereby calculating the same number of integrated vectors as the integration number.

Consequently, the same number of integrated vectors as the integration number may be easily created. Furthermore, at this time, by using the keys and values generated from the image feature vectors for the inner product, the keys and values are reflected as a weighted sum.

Furthermore, the object integration unit 103 is arranged upstream of the reference network, and additionally the vectorized sentence (sentence feature vector) is input to both of the task neural network and the reference network.

Then, the reference network acquires the value generated from each word based on the correlation between the query (Q) generated from the feature vector of the object (partial image) and the key (K) generated from each word (token) in the sentence, and adds the acquired value to the feature vector of the original object.

This reflects weighting based on the sentence in the feature vector (image feature vector) of the object input to the object integration unit 103, and the object integration unit 103 integrates only objects associated with the question text. Consequently, objects that have high association with the question text may be integrated, and the integration of objects that match the question text may be achieved.

(D) Others

FIG. 12 is a diagram depicting a hardware configuration of an information processing device (a computer or an output device) that achieves the computer system 1 as an example of the embodiment.

The computer system 1 includes, for example, a processor 11, a memory unit 12, a storage device 13, a graphic processing device 14, an input interface 15, an optical drive device 16, a device connection interface 17, and a network interface 18 as constituent elements. These constituent elements 11 to 18 are configured such that communication with each other is enabled via a bus 19.

The processor (control unit) 11 controls the entire present computer system 1. The processor 11 may be a multiprocessor.

The processor 11 may be, for example, any one of a central processing unit (CPU), a micro processing unit (MPU), a digital signal processor (DSP), an application specific integrated circuit (ASIC), a programmable logic device (PLD), and a field programmable gate array (FPGA). Furthermore, the processor 11 may be a combination of two or more types of elements of the CPU, MPU, DSP, ASIC, PLD, and FPGA.

Then, the functions as the sentence input unit 101, the image input unit 102, the object integration unit 103, and the task processing unit 104 depicted in FIG. 1 are achieved by the processor 11 executing a control program (machine learning program: not illustrated).

Note that the computer system 1 executes a program [the machine learning program or an operating system (OS) program] recorded on, for example, a computer-readable non-transitory recording medium to achieve the functions as the sentence input unit 101, the image input unit 102, the object integration unit 103, and the task processing unit 104.

The program in which processing contents to be executed by the computer system 1 are described may be recorded on a variety of recording media. For example, the program to be executed by the computer system 1 may be stored in the storage device 13. The processor 11 loads at least a part of the program in the storage device 13 into the memory unit 12 and executes the loaded program.

Furthermore, the program to be executed by the computer system 1 (processor 11) may be recorded on a non-transitory portable recording medium such as an optical disc 16a, a memory device 17a, or a memory card 17c. The program stored in the portable recording medium can be executed after being installed in the storage device 13, for example, under the control of the processor 11. Furthermore, the processor 11 may also directly read and execute the program from the portable recording medium.

The memory unit 12 is a storage memory including a read only memory (ROM) and a random access memory (RAM). The RAM of the memory unit 12 is used as a main storage device of the computer system 1. The RAM temporarily stores at least a part of the OS program and the control program to be executed by the processor 11. Furthermore, the memory unit 12 stores various sorts of data needed for the processing by the processor 11.

The storage device 13 is a storage device such as a hard disk drive (HDD), a solid state drive (SSD), or a storage class memory (SCM) and stores various kinds of data. The storage device 13 is used as an auxiliary storage device of the computer system 1. The storage device 13 stores the OS program, the control program, and various sorts of data. The control program includes the machine learning program.

Note that a semiconductor storage device such as an SCM or a flash memory may also be used as the auxiliary storage device. Furthermore, redundant arrays of inexpensive disks (RAID) may be formed using a plurality of the storage devices 13.

Furthermore, the storage device 13 may store various sorts of data generated when the sentence input unit 101, the image input unit 102, the object integration unit 103, and the task processing unit 104 described above execute each piece of processing.

For example, the sentence feature vector generated by the sentence input unit 101 and the image feature vector generated by the image input unit 102 may be stored. In addition, the seed vector generated by the seed generation unit 131, the query generated by the query generation unit 133, the key generated by the key generation unit 134, the value generated by the value generation unit 135, and the like may be stored.

The graphic processing device 14 is connected to a monitor 14a. The graphic processing device 14 displays an image on a screen of the monitor 14a in accordance with a command from the processor 11. Examples of the monitor 14a include a display device using a cathode ray tube (CRT), and a liquid crystal display device.

The input interface 15 is connected to the keyboard 15a and the mouse 15b. The input interface 15 transmits signals sent from the keyboard 15a and the mouse 15b to the processor 11. Note that the mouse 15b is one example of a pointing device, and another pointing device may also be used. Examples of another pointing device include a touch panel, a tablet, a touch pad, and a track ball.

The optical drive device 16 reads data recorded on the optical disc 16a using laser light or the like. The optical disc 16a is a non-transitory portable recording medium having data recorded in a readable manner by reflection of light. Examples of the optical disc 16a include a digital versatile disc (DVD), a DVD-RAM, a compact disc read only memory (CD-ROM), and a CD-recordable (R)/rewritable (RW).

The device connection interface 17 is a communication interface for connecting peripheral devices to the computer system 1. For example, the device connection interface 17 may be connected to the memory device 17a and a memory reader/writer 17b. The memory device 17a is a non-transitory recording medium equipped with a communication function with the device connection interface 17 and is, for example, a universal serial bus (USB) memory. The memory reader/writer 17b writes data to the memory card 17c or reads data from the memory card 17c. The memory card 17c is a card-type non-transitory recording medium.

The network interface 18 is connected to a network (not illustrated). The network interface 18 may be connected to another information processing device, a communication device, and the like via a network. For example, the input image or the input sentence may be input via a network.

As described above, in the computer system 1, the functions as the sentence input unit 101, the image input unit 102, the object integration unit 103, and the task processing unit 104 depicted in FIG. 1 are achieved by the processor 11 executing the control program (machine learning program: not illustrated).

Then, the disclosed technique is not limited to the above-described embodiment, and various modifications may be made and implemented without departing from the gist of the present embodiment. Each configuration and each piece of processing of the present embodiment may be selected or omitted as needed or may be appropriately combined.

For example, in the above-described embodiment, an example in which the object integration unit 103 is arranged between the reference network and the task neural network is indicated (refer to FIG. 4), but the embodiment is not limited to this example.

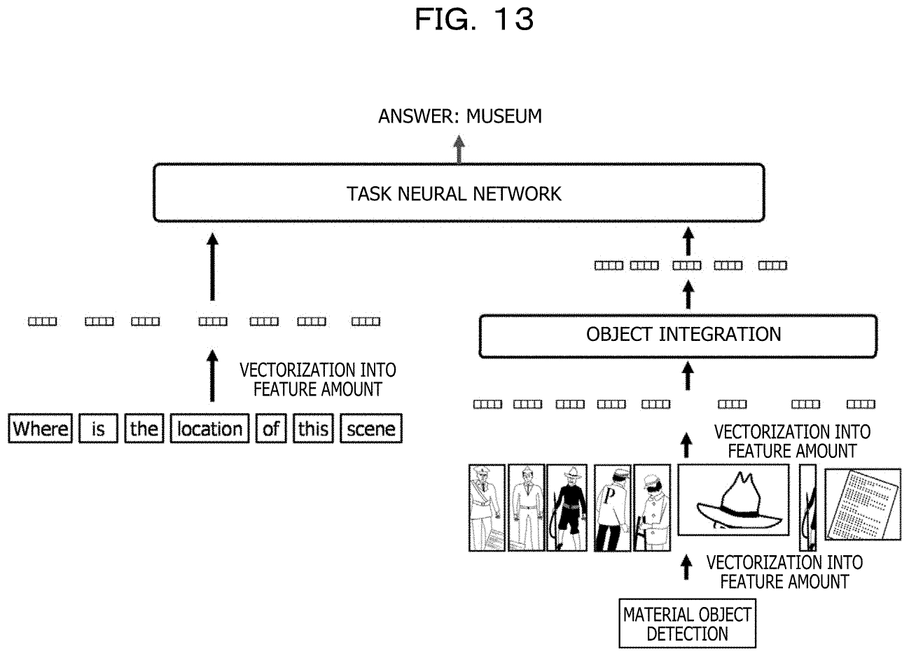

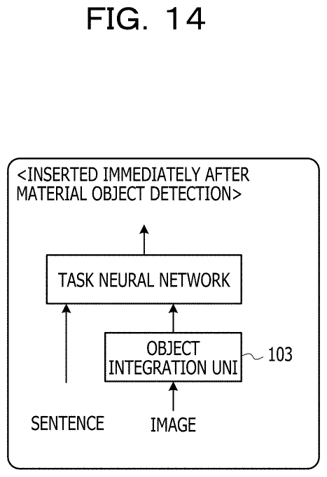

FIGS. 13 and 14 are diagrams depicting arrangements of an object integration unit 103 of a computer system 1 as a modification of the embodiment.

In the example illustrated in FIG. 13, the object integration unit 103 is arranged on an upstream side of the task neural network at a position immediately after the object detection by an image input unit 102.

With this configuration, as illustrated in FIG. 14, the image feature vector generated by the image input unit 102 is input to the object integration unit 103, and the object integration unit 103 performs the integration such that a specified number (integration number) is obtained.

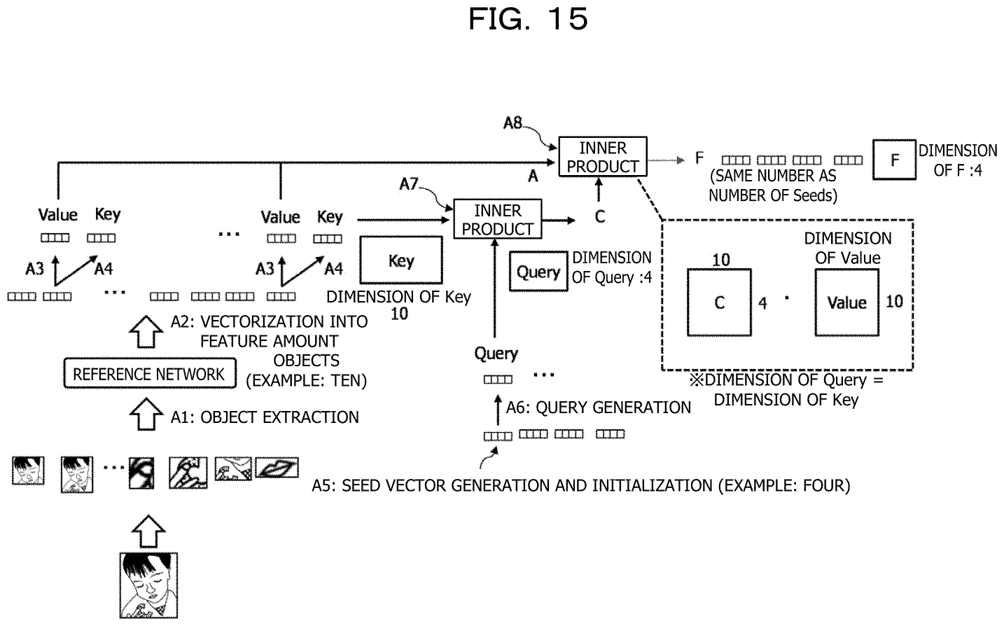

The processing in the computer system 1 as the modification of the embodiment configured as described above will be described with reference to FIG. 15.

The processing illustrated in FIG. 15 differs from the processing illustrated in FIG. 8 in that a plurality of image feature vectors generated by the image input unit 102 is input to the reference network (refer to the reference sign A2).

Furthermore, a value generation unit 135 and a key generation unit 134 generate values and keys based on the image feature vectors output from this reference network (refer to the reference signs A3 and A4).

Note that, in the drawing, similar parts to the aforementioned parts are denoted by the same reference signs as those of the aforementioned parts, and thus the description of the similar parts will be omitted.

In the modification of the present computer system 1, the object integration unit 103 is arranged upstream of the reference network, such that the objects are integrated based on only the input image.

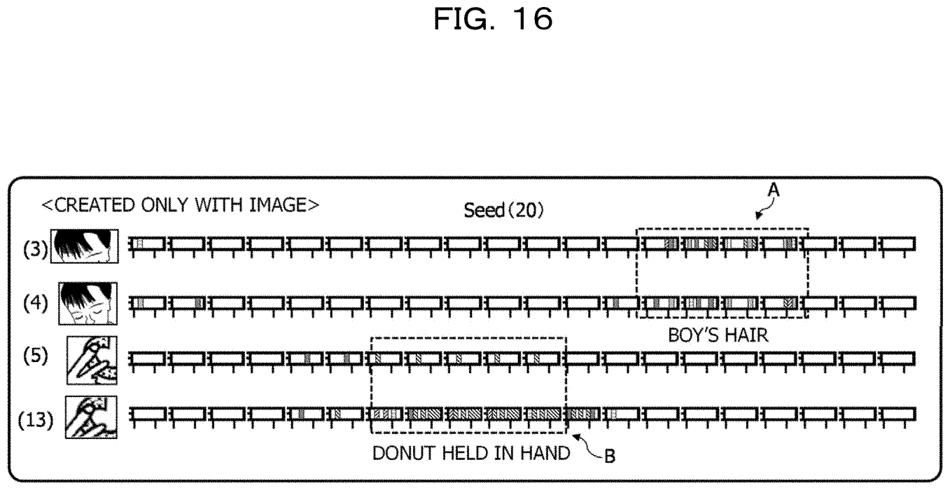

FIG. 16 is a diagram for explaining objects integrated in the computer system 1 as the modification of the embodiment.

Also in FIG. 16, similar to FIG. 9, an example of vectors in which a plurality of objects generated based on a photograph (input image) of a kid's face are integrated is represented. Also in this FIG. 16, an example in which the number of seeds is 20 is illustrated.

By integrating objects based only on the input image, objects having a close distance or resembling objects are integrated.

In the example illustrated in FIG. 16, for example, attention is focused on a vector relevant to the kid's hair and a vector relevant to the donut held by the kid in a hand (refer to the reference signs A and B).

Furthermore, in the above-described embodiment, an example in which the object integration unit 103 integrates image objects (image feature vectors) has been indicated, but the embodiment is not limited to this example. The object integration unit 103 may integrate objects other than images and may be altered and implemented as appropriate. For example, the object integration unit 103 may integrate the sentence feature vectors using a similar approach.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a machine learning program for causing a computer to execute a process comprising:
acquiring a plurality of vectors that indicate a feature of each of a plurality of partial images extracted from an image;
calculating a same number of vectors as a certain number of vectors based on the plurality of vectors and the certain number of vectors; and
changing parameters of a neural network by executing machine learning based on vectors that indicate a feature of text and the same number of vectors.

2. The non-transitory computer-readable storage medium according to claim 1, wherein the process further comprising:
generating the same number of seeds as the certain number,
setting different initial values for each of the seeds, and
generating query vectors from each of the seeds.

3. The non-transitory computer-readable storage medium according to claim 2, wherein the process further comprising:
generating value vectors and key vectors from each of the plurality of vectors acquired from the plurality of partial images,
calculating a correlation from an inner product between the key vectors and the query vectors, and
calculating the same number of vectors from the inner product between the value vectors and the correlation.

4. The non-transitory computer-readable storage medium according to claim 1, wherein the process further comprising
updating the certain number of vectors according to the machine learning.

5. The non-transitory computer-readable storage medium according to claim 1, wherein the process further comprising
based on the correlation between the query vectors generated from the vectors that indicate the feature of the partial images and the key vectors generated from tokens contained in the text, acquiring the value vectors generated from each of the tokens, and adding the acquired value vectors to the vectors that indicate the feature of the partial images.

6. A machine learning method for a computer to execute a process comprising:
acquiring a plurality of vectors that indicate a feature of each of a plurality of partial images extracted from an image;
calculating a same number of vectors as a certain number of vectors based on the plurality of vectors and the certain number of vectors; and
changing parameters of a neural network by executing machine learning based on vectors that indicate a feature of text and the same number of vectors.

7. The machine learning method according to claim 6, wherein the process further comprising:
generating the same number of seeds as the certain number,
setting different initial values for each of the seeds, and
generating query vectors from each of the seeds.

8. The machine learning method according to claim 7, wherein the process further comprising:
generating value vectors and key vectors from each of the plurality of vectors acquired from the plurality of partial images,
calculating a correlation from an inner product between the key vectors and the query vectors, and
calculating the same number of vectors from the inner product between the value vectors and the correlation.

9. The machine learning method according to claim 6, wherein the process further comprising
updating the certain number of vectors according to the machine learning.

10. The machine learning method according to claim 6, wherein the process further comprising
based on the correlation between the query vectors generated from the vectors that indicate the feature of the partial images and the key vectors generated from tokens contained in the text, acquiring the value vectors generated from each of the tokens, and adding the acquired value vectors to the vectors that indicate the feature of the partial images.

11. An output device comprising:
one or more memories; and
one or more processors coupled to the one or more memories and the one or more processors configured to
acquire a plurality of vectors that indicate a feature of each of a plurality of partial images extracted from an image,
calculate a same number of vectors as a certain number of vectors based on the plurality of vectors and the certain number of vectors, and
change parameters of a neural network by executing machine learning based on vectors that indicate a feature of text and the same number of vectors.

12. The output device according to claim 11, wherein the one or more processors further configured to:
generate the same number of seeds as the certain number,
set different initial values for each of the seeds, and
generate query vectors from each of the seeds.

13. The output device according to claim 12, wherein the one or more processors further configured to:
generate value vectors and key vectors from each of the plurality of vectors acquired from the plurality of partial images,
calculate a correlation from an inner product between the key vectors and the query vectors, and
calculate the same number of vectors from the inner product between the value vectors and the correlation.

14. The output device according to claim 11, wherein the one or more processors further configured to
update the certain number of vectors according to the machine learning.

15. The output device according to claim 11, wherein the one or more processors further configured to
based on the correlation between the query vectors generated from the vectors that indicate the feature of the partial images and the key vectors generated from tokens contained in the text, acquire the value vectors generated from each of the tokens, and adding the acquired value vectors to the vectors that indicate the feature of the partial images.
